(19) United States
(12) Patent Application Publication
(10) Pub. No.: US 2025/0115324 A1
(43) Pub. Date: Apr. 10, 2025

(54) Footrest Apparatus for a Tilting Vehicle

(71) Applicant: Bayerische Motoren Werke Aktiengesellschaft, Muenchen (DE)

(72) Inventors: Maximilian INDERWIES, Muenchen (DE); Simon LEHRICH, Hildesheim (DE)

(21) Appl. No.: 18/730,359

(22) PCT Filed: Mar. 14, 2023
(86) PCT No.: PCT/EP2023/056458

§ 371 Date: Jul. 19, 2024

(30) Foreign Application Priority Data
Mar. 30, 2022 (DE) 10 2022 107 469.2

(51) Int. Cl. B62J 25/06

(52) U.S. Cl. CPC B62J 25/06

(57) ABSTRACT

A footrest apparatus for a tilting vehicle can be arranged or is arranged on a vehicle component of the tilting vehicle, such as a vehicle seat. The apparatus includes at least one receiving unit, which is arranged in or on the vehicle component and has at least one opening, through which the receiving unit is accessible from the outside, and at least one footrest, which can be transferred from a support position, in which a foot of a user of the tilting vehicle can be supported on the footrest, into a stowed position, in which the footrest is pushed fully or at least partly into the receiving unit through the opening in the receiving unit and is arranged in the receiving unit in full or at least with an area that is larger than in the support position.

### BACKGROUND AND SUMMARY

The invention relates to a footrest apparatus for a tilting vehicle.

Footrests for tilting vehicles are known, for example, in the form of what are referred to as pillion passenger footrests, i.e. footrests on which a passenger can rest their feet during the operation of the tilting vehicle. Footrest apparatuses in the form of pillion passenger footrests are not always used during operation of the tilting vehicle, but only if a passenger is being taken along. When a single person is driving the tilting vehicle, the pillion passenger footrests are not required.

It is known from the prior art to secure footrest apparatuses in the form of pillion passenger footrests on the tilting vehicle either rigidly and in a fixed position or to transfer same from a support position, in which a passenger's foot can be supported on the footrest, into a storage position by means of rotation, in which the footrest is arranged on a paneling, in particular below a vehicle seat.

It has proven disadvantageous in this connection that, during operation of the tilting vehicle, a user of the tilting vehicle may make contact with the footrest apparatus in the form of pillion passenger footrests during driving or during maneuvring, which reduces the driving comfort.

If the pillion passenger footrests are formed immovably and in a fixed position and rigidly relative to the tilting vehicle, the footrests protrude outward unnecessarily, which leads to a deterioration in the streamlining.

Screwing on and unscrewing rigid, positionally fixed footrests is inconvenient and time-consuming.

It is an object of an exemplary embodiment of the invention to provide a footrest apparatus for a tilting vehicle, which footrest apparatus, when not required, can be stored better.

This object is achieved by a footrest apparatus for a tilting vehicle, which footrest apparatus can be arranged or is arranged on a vehicle component of the tilting vehicle, such as a vehicle seat, having at least one receiving unit, which is arranged in or on the vehicle component and which comprises at least one opening, through which the receiving unit is accessible from the outside, having at least one footrest, which can be transferred from a support position, in which a foot of the user of the tilting vehicle can be supported on the footrest, into a storage position, in which the footrest is pushed entirely or at least in sections through the opening in the receiving unit into the receiving unit and is arranged in the receiving unit completely or at least with a region which is larger than in the support position.

Owing to the fact that the footrest apparatus comprises at least one footrest which can be transferred from a support position, in which a foot of a user of the tilting vehicle can be supported on the footrest, into a storage position, in which the footrest is pushed entirely or at least in sections through the opening in the receiving unit into the receiving unit and is arranged in the receiving unit completely or at least with a region which is larger than in the support position, the footrest protrudes only slightly, if at all, laterally beyond the tilting vehicle in the storage position. By this means, the effect on streamlining is reduced as is the risk of a user of the tilting vehicle being able to make contact with the footrest of the footrest apparatus while underway.

The receiving unit can be arranged in or on a vehicle component. In embodiments, provision is made that the vehicle component comprises a vehicle seat on which or in which the receiving unit is formed. The receiving unit can comprise just one receiving base on which the at least one footrest is arranged and held lying in the storage position or can be formed in the manner of a housing comprising a cavity and predominantly surrounding the cavity.

The at least one footrest can be transferred from the support position into the storage position and back manually or automatically. If the at least one footrest is transferred automatically, in such a case a drive, in particular a mechanical or electric drive, can be provided.

By means of the transfer by pushing in from the support position into the storage position and vice versa, the transfer movement comprises at least one translation movement.

A tilting vehicle is understood as meaning bicycles, motorbikes or motor vehicles similar to motorbikes, such as motor scooters, in particular two-, three- or four-wheeled motor scooters, scooters, tiltable trikes, quad bikes or the like.

In principle, it is contemplated for the footrest to be formed from a single rectilinear or curved element. In one embodiment of the footrest apparatus, it has proven advantageous if the at least one footrest comprises a leg element, which is arranged with an engage-behind portion in the storage position and in the support position in the receiving unit, and if the at least one footrest comprises a support element, which is arranged at the end of the leg element which faces away from the engage-behind portion and, at least in the support position, runs obliquely or transversely with respect to the leg element and on which the foot of a user of the tilting vehicle can be supported in the support position.

Owing to the fact that the footrest comprises a leg element, which is arranged with an engage-behind portion in the storage position and in the support position in the receiving unit, the footrest is always secured in the receiving unit against removal from the receiving unit. By this means, the footrest is secured captively in the receiving unit.

Owing to the fact that the footrest comprises a support element which runs obliquely or transversely to the leg element and which is arranged on an end of the leg element facing away from the engage-behind portion, a relative height with respect to the tilting vehicle, at which height the support element is located, can be formed independently of the arrangement of the receiving unit. The receiving unit can thus be arranged, for example, on a seat device of the tilting vehicle, and the support element, by enclosing the leg element and running obliquely or transversely with respect to the leg element, can be located spaced apart from the seat device and from the receiving unit, in particular with respect to the vertical axis of the tilting vehicle. By this means, a comfortable arrangement of the legs of a user can be ensured by the footrest apparatus.

In a development of the last-mentioned embodiment, it has proven advantageous if the leg element and the support element of the footrest form an integral, common component, or if the leg element and the support element of the footrest comprise components which are separate or separable from one another.

If the leg element and support element form an integral, common component, the footrest apparatus can be formed with a reduced number of components. If the leg element and the support element of the footrest comprise components which are separate or separable from one another, leg elements of differing length can be joined together with support elements of differing length in order to form a footrest.

Furthermore, embodiments of the footrest apparatus are contemplated, in which the support element is arranged on the leg element immovably relative to the leg element and positionally fixed, or in which the support element is arranged on the leg element movably, in particular rotatably, relative to the leg element and can be transferred from a support position, in which the foot of the user of the tilting vehicle can be supported on the support element in the support position, into a folding position, in which a free end of the support element is arranged moved in the direction of the leg element with respect to the support position.

If the support element is arranged on the leg element immovably relative to the leg element and positionally fixed, an angle between the support element and leg element is always constant. In such a case, the support element can lie from the outside on the receiving unit in the storage position.

If the support element is movable relative to the leg element, in particular is arranged rotatably on the leg element and can be transferred from a support position, in which the foot of the user of the tilting vehicle can be supported on the support element in the support position, into a folding position, in which a free end of the support element is arranged moved with respect to the support position in the direction of the leg element, the support element can lie on the leg element. In such a case, the support element and leg element can be arranged in the storage position in the receiving unit.

In order to be able to ensure that loads are absorbed in the support position, it has proven advantageous if the receiving unit comprises a wedge-shaped contact portion which is adjacent to the opening and on the first surface of which the leg element lies with its engage-behind portion in the support position so as to form an engagement from behind with respect to the opening and on the second surface of which, that is adjacent to the first surface, the leg element lies extensively at least in sections in the support position.

The wedge-shaped contact portion can be formed, for example, by a step between a base surface and an opening in the receiving unit. The engage-behind portion of the leg element can be realized in the manner of a step or in the manner of a hook.

Owing to the fact that the receiving unit comprises a wedge-shaped contact portion adjacent to the opening, the leg element is hooked by its engage-behind portion on the wedge-shaped contact portion in the support position and lies in sections on the wedge-shaped contact portion. By this means, loads which are transmitted to the footrest, for example, by a foot or a leg of a user of the footrest, can be absorbed by the receiving unit.

The absorption of loads can be further improved and a relative movement of the leg element with respect to the receiving unit can be limited if the receiving unit comprises a stop portion which is arranged on a side of the opening lying opposite the contact portion and on which the leg element lies extensively or linearly in the support position.

In such a case, the leg element lies with a side opposite the engage-behind portion on the stop portion of the receiving unit. In principle, it is conceivable for the footrest apparatus to comprise a plurality of receiving units, with in each case one footrest being arranged in each receiving unit. Preferred embodiments of the tilting vehicle comprise footrest apparatuses in which a respective footrest is arranged on both sides of the tilting vehicle.

The footrest apparatus can be formed compactly if the receiving unit comprises at least two mutually opposite openings through which the receiving unit is accessible from the outside and in which a first footrest can be transferred through a first opening from the support position into the storage position and in which a second footrest can be transferred from the support position into the storage position, wherein the first footrest and the second footrest are arranged in the receiving unit overlapping each other at least in sections and lying against each other in the storage position.

In such a case, two footrests can be arranged in one and the same receiving unit. Owing to the fact that the two openings lie opposite each other, both the left side and the right side of the tilting vehicle can comprise a footrest which can be transferred from the storage position into the support position.

Owing to the fact that a first footrest and a second footrest are arranged in the receiving unit overlapping each other at least in sections and lying against each other in the storage position, the footrest apparatus can be formed compactly and in a manner optimized in terms of construction space.

To this end, it has proven advantageous in particular if the leg element of the at least one footrest comprises a solid profile or a hollow profile, in particular if the leg element of the first footrest comprises a hollow profile, and if the leg element of the second footrest comprises a solid profile.

If the leg element of the at least one footrest comprises a solid profile, the footrest apparatus can be produced simply and cost-effectively. If the leg element comprises a hollow profile, the footrest can be formed in a manner optimized in terms of weight. If the leg element of the first footrest comprises a hollow profile and if the leg element of the second footrest comprises a solid profile, the solid profile of the leg element of the second footrest can lie extensively on the leg element of the first footrest in the storage position. In such a case, the hollow profile of the leg element of the first footrest surrounds the leg element of the second footrest in the manner of rails from at least two sides in the storage position.

Furthermore, embodiments of the footrest apparatus are conceivable, in which a leg element comprising a hollow profile comprises at least two leg portions which are telescopic one inside the other, wherein the leg element comprises its longest extent in the support position and its shortest extent in the storage position.

If the leg element comprising a hollow profile comprises at least two leg portions which are telescopic one inside the other, the longitudinal extent of the leg element can be adjusted. By this means, the footrest apparatus can be formed with a reduced construction space. In such a case, it is contemplated, for example, for the leg element to be reduced with respect to its longitudinal extent when it is transferred from the support position into the storage position and to comprise its shortest extent in the storage position.

Simple embodiments of the leg element can make provision in such a case that the leg element comprises a stop in its longest extent for the at least two leg portions and in such a case the leg element can be arranged exclusively in two positions, namely longest extent and shortest extent.

Furthermore, it is contemplated for the leg element to be able to be secured in different longitudinal extents in steps or continuously. In such a case, a drive can be provided in the leg element or the leg element can be adjusted manually in steps or continuously.

In order to prevent the at least one footrest in the storage position from being unintentionally moved out of the receiving unit during the operation of the tilting vehicle, in which production of vibrations can never be completely excluded, in one embodiment of the footrest apparatus at least one mechanically or magnetically effective securing means is provided by which the at least one footrest, in particular the first footrest and the second footrest, is secured releasably against moving in the storage position, wherein the at least one footrest can be released from the secured arrangement when a retaining force of the securing means is exceeded and can be transferred into the support position.

Further features, details and advantages of the invention emerge from the attached claims, from the graphical illustration and description below of a preferred embodiment of the footrest apparatus.

### BRIEF DESCRIPTION OF THE DRAWINGS

FIG. 1 is a sectional view of an embodiment of the footrest apparatus in the support position of the footrests; and

FIG. 2 is a sectional view of the embodiment of the footrest apparatus according to FIG. 1 in the storage position of the footrests.

### DETAILED DESCRIPTION OF THE DRAWINGS

The figures show a footrest apparatus, which is provided overall with the reference sign 2, for a tilting vehicle. The footrest apparatus 2 can be arranged or is arranged on a vehicle component 4 of the tilting vehicle, such as a vehicle seat.

The footrest apparatus 2 comprises a receiving unit 6, which is arranged in or on the vehicle component 4 and which comprises at least one opening 8.

In the exemplary embodiment shown in the figures, the receiving unit 6 comprises two openings 8 which are arranged on mutually opposite sides. The receiving unit 6 is accessible from the outside through the openings 8.

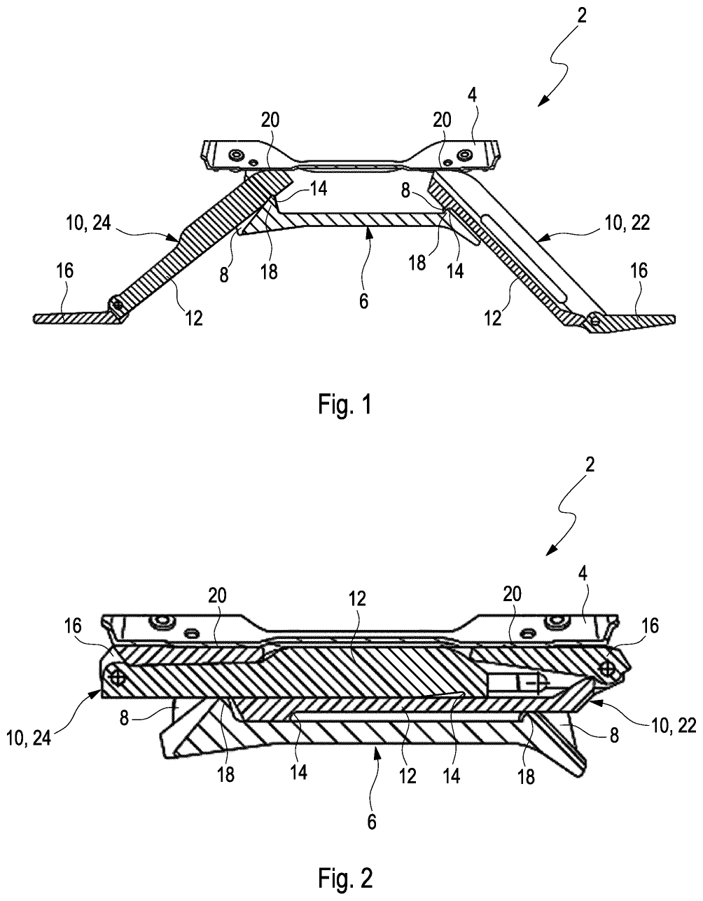

In the exemplary embodiment shown in the figures, the footrest apparatus 2 comprises two footrests 10 which can each be transferred from a support position, in which a foot of a user of the tilting vehicle can be supported on the footrest 10 (FIG. 1), into a storage position, in which the footrest 10 is pushed entirely or at least partially through the opening 8 in the receiving unit 6 into the receiving unit 6, and is arranged in the receiving unit 6 completely or at least with a region which is larger than in the support position (FIG. 2).

The footrests 10 each comprise a leg element 12 having an engage-behind portion 14. The engage-behind portion is in the receiving unit 6 in both the storage position and in the support position.

Furthermore, the footrest 10 comprises a support element 16, which is arranged at the end of the leg element 12 which faces away from the engage-behind portion 14 and which, in the support position, in the exemplary embodiment shown in the figures, runs obliquely with respect to the leg element 12. A foot of a user of the tilting vehicle can be supported on the support element 16 in the support position.

In the exemplary embodiment shown in the figures, the leg element 12 and the support element 16 are formed as components which are separate and are separable from each other. The support element 16 is rotatable about an axis of rotation with respect to the leg element 12. In this connection, it can be transferred from a support position (FIG. 1), in which the foot of the user of the tilting vehicle can be supported on the support element 16 in the support position, into a folding position (FIG. 2), in which the free end of the support element 16 is arranged movably in the direction of the leg element 12 with respect to the seat position. The support element 16 lies here on the leg element 12.

The receiving unit 6 comprises two wedge-shaped contact portions 18 which are each adjacent to the openings 8 and on the first surface of which the leg element 12 lies with its engage-behind portion 14 in the support position so as to form an engagement from behind with respect to the opening 8 and on the second surface of which, that is adjacent to the first surface, the leg element 12 lies extensively at least in sections in the support position. Lying opposite the wedge-shaped portion 18 with respect to the opening 8, the receiving unit 6 comprises a stop portion 20 on which the respective footrest 10 lies extensively or linearly in the support position with a side of the leg element 12 lying opposite the engage-behind portion 14.

The figures show an exemplary embodiment in which the leg element 12 of a first footrest 22 comprises a hollow profile and the leg element 12 of a second footrest 24 comprises a solid profile. It is thereby made possible, in the storage position, to arrange the second footrest 24 in the receiving unit 6 overlapping with the first footrest 22 and in contact extensively with one another and with a reduced amount of construction space.

The operation of the footrest apparatus 2 will be outlined briefly below.

From a storage position according to FIG. 2, the second footrest 24 is first of all pulled out of the receiving unit 6. The second footrest 24 passes through the opening 8 and, in the support position, lies with the engage-behind portion 14 of the leg element 12 on the wedge-shaped contact portion 18 of the receiving unit 6. At the same time, the leg element 12 of the second footrest 24 is supported on the side opposite the engage-behind portion 14 by contact with the stop portion 20. The support element 16 is folded over and in such a case forms, according to the arrangement according to FIG. 1, a support for a foot of a user of the tilting vehicle.

The procedure is the same with the second footrest 24.

From the arrangement according to FIG. 1 of the support position, the footrest apparatus 2 can be transferred again into the storage position. The previously described steps are reversed in this case.

The features of the invention disclosed in the above description, in the claims and in the drawing may be essential both individually and in any desired combination in the implementation of the invention in its various embodiments.

### LIST OF REFERENCE SIGNS

2 footrest apparatus
4 vehicle component
6 receiving unit
8 opening
10 footrest
12 leg element
14 engage-behind portion
16 support element
18 contact portion
20 stop portion
22 first footrest
24 second footrest

1.-10. (canceled)

11. A footrest apparatus for a tilting vehicle arrangeable on a vehicle component of the tilting vehicle, comprising:
at least one receiving unit arranged in or on the vehicle component and comprising at least one opening, through which opening the receiving unit is accessible from outside;
at least one footrest transferable from a support position, in which a foot of a user of the tilting vehicle is supportable on the footrest, into a storage position, in which the footrest is pushed entirely or at least partially through the opening into the receiving unit so as to be arranged in the receiving unit completely or at least with a region which is larger than in the support position.

12. The footrest apparatus according to claim 11, wherein
the at least one footrest comprises a leg element arranged such that an engage-behind portion is located in the receiving unit in the storage position and in the support position, and
the at least one footrest further comprises a support element arranged at an end of the leg element which faces away from the engage-behind portion and, at least in the support position, extends obliquely or transversely with respect to the leg element and on which the foot of the user of the tilting vehicle is supportable in the support position.

13. The footrest apparatus according to claim 12, wherein
the leg element and the support element of the footrest form an integral, common component, or
the leg element and the support element of the footrest comprise components which are separate or separable from one another.

14. The footrest apparatus according to claim 12, wherein
the support element is arranged on the leg element immovably relative to the leg element and positionally fixed, or
the support element is arranged on the leg element movably relative to the leg element and is transferrable from a support position, in which the foot of the user of the tilting vehicle is supportable on the support element in the support position, into a folding position, in which a free end of the support element is moved in the direction of the leg element with respect to the support position.

15. The footrest apparatus according to claim 12, wherein
the receiving unit comprises a wedge-shaped contact portion which is adjacent to the opening and on a first surface of which the leg element lies with its engage-behind portion in the support position so as to form an engagement from behind with respect to the opening and, on a second surface of which, that is adjacent to the first surface, the leg element lies extensively at least in sections in the support position.

16. The footrest apparatus according to claim 16, wherein
the receiving unit comprises a stop portion which is arranged on a side of the opening lying opposite the wedge-shaped contact portion and on which the leg element lies extensively or linearly in the support position.

17. The footrest apparatus according to claim 11, wherein
the receiving unit comprises at least two mutually opposite openings through which the receiving unit is accessible from the outside and in which a first footrest is transferable through a first opening from the support position into the storage position and in which a second footrest is transferable from the support position into the storage position, and
the first footrest and the second footrest are arranged in the receiving unit overlapping each other at least partly and lying against each other in the storage position.

18. The footrest apparatus according to claim 11, wherein
the leg element of the at least one footrest comprises a solid profile or a hollow profile.

19. The footrest apparatus according to claim 17, wherein
the leg element of the first footrest comprises a hollow profile, and the leg element of the second footrest comprises a solid profile.

20. The footrest apparatus according to claim 18, wherein
the leg element comprising the hollow profile comprises at least two leg portions which are telescopic one inside the other, wherein the leg element comprises its longest extent in the support position and its shortest extent in the storage position.

21. The footrest apparatus according to claim 11, further comprising:
at least one mechanically or magnetically effective securing device by which the at least one footrest is secured releasably against moving in the storage position, wherein
the at least one footrest is released from being secured when a retaining force of the securing device is exceeded, and is transferred into the support position.
